(19) United States
(12) Patent Application Publication
(10) Pub. No.: US 2015/0365621 A1
(43) Pub. Date: Dec. 17, 2015

(54) BACKLIGHT CONTROL APPARATUS OF LIQUID CRYSTAL PANEL, LIQUID CRYSTAL TV SET AND MCU CHIP

(71) Applicants: Hisense Electric Co., Ltd, Qingdao (CN); HISENSE USA CORPORATION, Suwanee, GA (US)

(72) Inventors: Yuxin ZHANG, Qingdao (CN); Shunming HUANG, Qingdao (CN); Jianwei CAO, Qingdao (CN); Mingsheng QIAO, Qingdao (CN)

(21) Appl. No.: 14/317,021

(22) Filed: Jun. 27, 2014

(30) Foreign Application Priority Data
Jun. 16, 2014 (CN) 201410267408.5

(51) Int. Cl. H04N 5/70; H04N 7/015; G09G 3/34; H04N 5/74; G09G 3/36; G09G 5/00

(52) U.S. Cl. CPC H04N 5/70; G09G 3/3607; G09G 3/3659; G09G 5/005; G09G 3/3406; H04N 5/7408; H04N 7/015; G09G 2320/0252; G09G 2320/0261; G09G 2340/16; G09G 2340/0435

(57) ABSTRACT

A backlight control apparatus of a liquid crystal panel, a liquid crystal TV set and an MCU chip are disclosed, and the apparatus includes: an FRC chip, an MCU chip connected with the FRC chip, and a backlight drive chip connected with the MCU chip; and calculates brightness data of N image zones of a current image frame, converts the brightness data of the N image zones into backlight values of N backlight zones and sends the backlight values to the Micro Controller Unit (MCU) chip; and divides the N backlight zones into M backlight areas, searches a preset gain curve for a gain corresponding to each backlight area according to the average of the backlight values of the backlight zones included in the each backlight area, and adjusts the backlight values of the N backlight zones by M gains searched for.

### CROSS-REFERENCE TO RELATED APPLICATION

This application claims priority to Chinese patent application No. 201410267408.5 filed on Jun. 16, 2014 and titled “BACKLIGHT CONTROL APPARATUS OF LIQUID CRYSTAL PANEL, LIQUID CRYSTAL TV SET AND MCU CHIP”, which is incorporated herein by reference in its entirety.

### FIELD

The present disclosure relates to the field of liquid crystal display technologies and particularly to a backlight control apparatus of a liquid crystal panel, a liquid crystal TV set and an MCU chip.

### BACKGROUND

The 4K resolution, which is the pixel resolution of 4096×2160, is four times the resolutions of a 2K projector and a high-definition TV set and falls into the category of ultra high-definition resolutions. A 4K TV set refers to a TV set with the 4K resolution, and as a new-generation commodity, the 4K TV set is configured with a new-generation high-definition 4K technology and a ultra-large panel to present a user with every detail and close-up in a display picture clearly and fully.

For a 4K liquid crystal TV set among 4K TV sets, resolution and frame rate conversion is typically implemented by Frame Rate Conversion (FRC) technology, but the FRC may be functionally simplex because an FRC chip is video-specific processing chip. Moreover since LED drive circuits are diversified due to the diversity of backlight models, if the various LED drive circuits are controlled by the FRC chip alone, then the possible differences between the numbers of LED drive circuits and between the models of LED drive circuits for different backlight zones may make it necessary for the FRC chip to control the various LED drive circuits respectively, thus definitely increasing the complexity of backlight control and lowering the stability of backlight control. Consequently only the resolution and frame rate conversion may be possible with the existing FRC chip and backlight drivers without significantly improving the brightness contrast of backlight and the layered perception of a display picture.

### SUMMARY

An embodiment of the disclosure provides a backlight control apparatus of a liquid crystal panel, including:

a Frame Rate Conversion (FRC) chip configured to calculate brightness data of N image zones of a current image frame, to convert the brightness data of the N image zones into backlight values of N backlight zones and to send the backlight values to a Micro Controller Unit (MCU) chip;

the MCU chip configured to divide the N backlight zones into M backlight areas, to search a preset gain curve for a gain corresponding to each backlight area according to an average of the backlight values of the backlight zones included in the each backlight area, to adjust the backlight values of the N backlight zones by the M gains searched for and to send the adjusted backlight values of the N backlight zones to a backlight drive chip, wherein both M and N are positive integers and M is no larger than N; and

the backlight drive chip configured to control Light Emitting Diode (LED) backlight sources of the N backlight zones by the received backlight values.

An embodiment of the disclosure further provides a liquid crystal TV set including the backlight control apparatus of the liquid crystal panel described above.

An embodiment of the disclosure further provides an MCU chip, including:

a reception unit configured to receive backlight values of N backlight zones;

a backlight area division unit configured to divide the N backlight zones into M backlight areas, to determine an average of the backlight values in each backlight area according to the backlight values of the backlight zones included in the backlight area;

a gain search unit configured to search a preset gain curve for a gain corresponding to the each backlight area according to the average of the backlight values in the each backlight area determined by the backlight area division unit; and

a backlight value adjustment unit configured to multiply the backlight values of the respective backlight zones in the corresponding backlight area by the M gains searched for by the gain search unit to derive the N backlight values enhanced by the gain.

### BRIEF DESCRIPTION OF THE DRAWINGS

In order to make the technical solutions in the embodiments of the disclosure more apparent, the drawings to be used in a description of the embodiments will be briefly introduced below, and apparently the drawings to be described below are merely illustrative of some embodiments of the disclosure, and those ordinarily skilled in the art can derive, from these drawings, other drawings without any inventive effort. In the drawings:

FIG. 1 is a schematic structural diagram of a backlight control apparatus of a liquid crystal panel 100 according to an embodiment of the disclosure;

FIG. 2(a) is a schematic diagram of a plurality of image zones as a result of division by a zone calculation unit according to an embodiment of the disclosure;

FIG. 2(b) is a schematic diagram of a plurality of backlight zones as a result of division by a backlight area division unit according to an embodiment of the disclosure;

FIG. 2(c) is a schematic diagram of a gain curve of a backlight value according to an embodiment of the disclosure;

FIG. 3 is a schematic diagram of the connection between the backlight control apparatus of the liquid crystal panel 100 and a liquid crystal display module 200 according to an embodiment of the disclosure;

FIG. 4 is a schematic diagram of a power adjustment curve according to an embodiment of the disclosure; and

FIG. 5 is a simplified structural diagram of a liquid crystal TV set according to an embodiment of the disclosure.

### DETAILED DESCRIPTION OF THE EMBODIMENTS

In order to make the objects, the technical solutions and the advantages of the disclosure more apparent, the disclosure will be further described in details with reference to the drawings. Apparently the described embodiments are only a part but not all of the embodiments of the disclosure. Based upon the embodiments of the disclosure here, all of other embodiments derived by those ordinarily skilled in the art without any inventive effort shall come into the scope of the disclosure.

In an embodiment of the disclosure, a backlight control apparatus of a liquid crystal panel including an FRC chip, an MCU chip and a backlight drive chip calculates brightness data of N image zones of a current image frame, converts the brightness data of the N image zones into backlight values of N backlight zones and sends the backlight values to the Micro Controller Unit (MCU) chip; and divides the N backlight zones into M backlight areas, searches a preset gain curve for a gain corresponding to each backlight area according to the average of the backlight values of the backlight zones included in the each backlight area, and adjusts the backlight values of the N backlight zones by the M gains searched for, so that the different gains can be searched for in accordance with the different backlight areas to perform different dimming control on the backlight zones and improve the brightness contrast of video data being displayed and the layered perception of a display picture.

The technical solution claimed by the disclosure will be described below in details in particular embodiments thereof, and the disclosure will not be limited to the following embodiments.

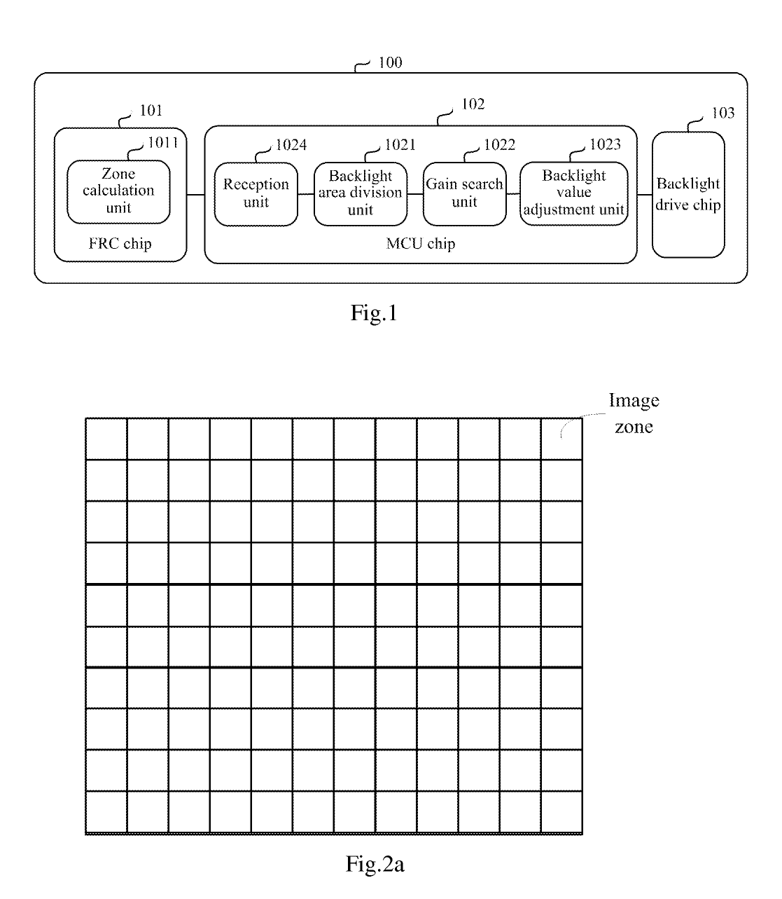

FIG. 1 shows a schematic structural diagram of a backlight control apparatus of a liquid crystal panel according to an embodiment of the disclosure, the apparatus including: a Frame Rate Conversion (FRC) chip 101, a Micro Controller Unit (MCU) chip 102 connected with the FRC chip 101, and a backlight drive chip 103 connected with the MCU chip 102.

Wherein, the FRC chip 101 is configured to calculate brightness data of N image zones of a current image frame, to convert the brightness data of the N image zones into backlight values of N backlight zones and to send the backlight values to the Micro Controller Unit (MCU) chip.

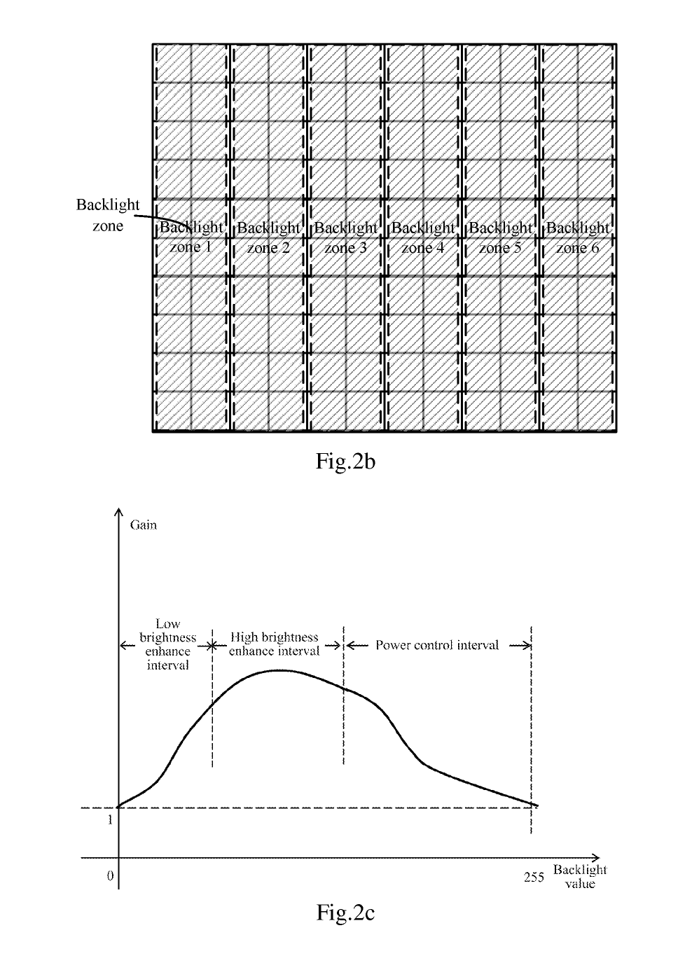

The FRC chip 101 is integrated therein with a zone calculation unit 1011 which is configured, for the acquired current image frame, to divide the current image frame into the N image zones (assumed 120 image zones as illustrated in FIG. 2(a)) according to a size of a backlight model, to count a grayscale histogram of pixels in each image zone respectively and further calculate the brightness data of each image zone (possibly including a plurality of pixels) and to convert the brightness data of the N image zones into the backlight values of the N backlight zones correspondingly.

Additionally in the embodiment of the disclosure, the FRC chip can be further integrated with a video adjustment unit 1012 configured to receive an image frame with the resolution of 2K (1920×1080) and to adjust resolution of image frame into an image frame with the resolution of 4K (4096×2160) so as to adapt the resolution of the image frame to the resolution of a display panel and have the image frame to be displayed as clear as possible on the display panel, wherein the brightness data of the each image zone is the average of the brightness data of all the pixels in the image zone. Moreover in the embodiment of the disclosure, alternatively the video adjustment unit can adjust resolution of the current image frame after the zone calculation unit 1011 determines the brightness data, but the disclosure will not be limited thereto.

The MCU chip 102 is configured to divide the N backlight zones into M backlight areas, to search a preset gain curve for a gain corresponding to each backlight area according to the average of the backlight values of the backlight zones included in the each backlight area, to adjust the backlight values of the N backlight zones by the M gains searched for and to send the adjusted backlight values of the N backlight zones to the backlight drive chip, wherein both M and N are positive integers and M is no larger than N; and the backlight zones can be divided by dividing the backlight zones into the M backlight areas with the same area or different areas according to any division criterion. Optionally in order to facilitate centrally zoned control, the backlight zones are divided so that the number of backlight zones is typically an integer multiple of the number of backlight areas as a result of division, and optionally the backlight zones can be uniformly divided according to a division criterion as illustrated in FIG. 2(b).

The MCU chip 102 is integrated therein with a backlight area division unit 1021, a gain search unit 1022 and a backlight value adjustment unit 1023, wherein the backlight area division unit 1021 is configured to divide the N backlight zones into the M backlight areas (assumed that 120 backlight zones are divided into 60 backlight areas as illustrated in FIG. 2(b)), to calculate the average of the backlight values in the each backlight area respectively according to the backlight values of the backlight zones included in the each backlight area; and the gain search unit 1022 is configured to search the preset gain curve for the gain corresponding to the each backlight area according to the average of the backlight values of the backlight zones included in the each backlight area determined by the backlight area division unit 1021, wherein the number of preset gain curves is no larger than M and preset gain curves are pre-stored in the gain search unit for a subsequent search. In one embodiment, if the backlight area division unit 1021 generates a backlight area 1 to a backlight area 6 and determines the averages of backlight vales respectively as 125, 189, 98, 176, 209 and 56, then at least one of the preset gain curves can be searched for a gain corresponding to each backlight area, and as illustrated in FIG. 2(c), there is a schematic diagram of a gain curve as a function of a backlight value according to the embodiment of the disclosure, where the abscissa represents a backlight value in the range of [0,255], and the ordinate represents a gain in the range of [1, +∞). However, the range of the gain can be set to [1, 2] as needed for real power setting in a practical implementation; and the gain will not be limited to an integer but can alternatively be a non-integer. The gain curve can be divided into a low brightness enhancement interval, a high brightness enhancement interval and a power control interval. When the average of the backlight values in a backlight area is lower, there is a gain in the low brightness enhancement interval; as display contents in the backlight area are changing, the average of the backlight values in the backlight area falls into the brightness enhancement interval, and there is a gain in the high brightness enhancement interval, thus making it possible to better highlight a bright section in a picture; and when the average of the backlight values in the backlight area is higher, further backlight enhancement will be substantially unnecessary because the brightness throughout the picture in the backlight area is sufficiently high, but on the contrary, the effect of a backlight gain shall be lowered due to power consumption. Since the determined averages of backlight lights in the respective backlight areas are different, the determined gains are also different, and furthermore the backlight value adjustment unit 1023 can multiply the backlight values of the backlight zones included in the corresponding backlight areas respectively by the 6 gains searched for by the gain search unit 1022 to derive N backlight values enhanced by the gains. As such, it is possible to perform different zoning dimming control on the respective backlight zones, so that there are different gains for the different backlight areas and furthermore the layered image perception and the brightness contrast of the picture being displayed can be improved. It is thus possible to avoid the problems in the prior art of the same gain throughout the backlight zones, and consequently an insignificant difference in brightness contrast and poor layered perception of the picture being displayed, due to centralized control on all the backlight zones.

Since in the prior art, there are a high brightness image zone, a low brightness image zone and an intermediate brightness image zone in the current image frame, when the average of brightness data in the current image frame is calculated, the average of brightness data typically comes into the high brightness interval of the gain curve with a larger gain, which have the brightness of all the corresponding backlight zones throughout the current image frame boosted and also their required power increased, and which may hinder an improvement in brightness contrast. With the disclosure, for the different backlight areas, the different gains can be searched for to assign the backlight zones with different brightness into the different backlight areas as many as possible, so that the different gains are searched for in accordance with the different backlight areas to avoid, for all the backlight zones, the same gain (which is a relatively large gain) searched for, thus improving to different degrees the brightness of the backlight zones corresponding to the entire image frame, lowering their required power and further facilitating separate control on the gains of the different backlight areas to further improve the brightness contrast and layered picture perception of the displayed picture.

The backlight drive chip 103 is configured to control the brightness of the N backlight zones by the received backlight values.

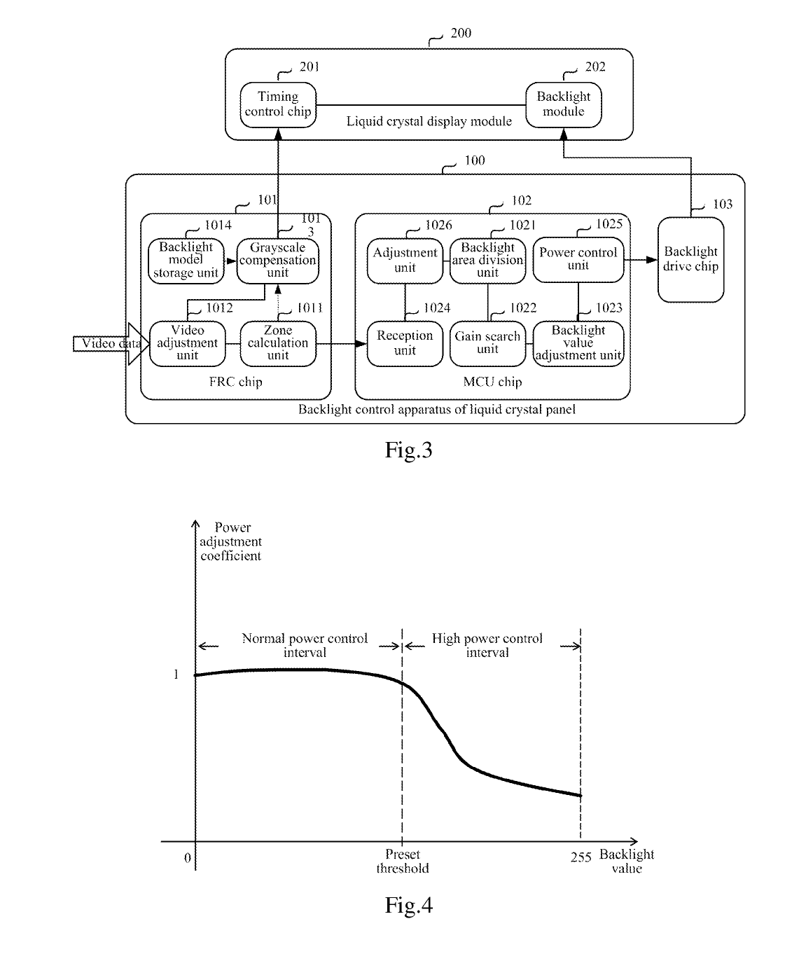

Additionally the FRC chip 101 is further integrated with a grayscale compensation unit 1013 configured to perform grayscale compensation on the image and a backlight model storage unit 1014 configured to store backlight model data. As illustrated in FIG. 3, the video adjustment unit 1012 can further perform frame rate conversion on received video data while adjusting resolution of the current image frame in the video data. The grayscale compensation unit 1013 performs grayscale compensation on the adjusted current image frame according to the backlight model data stored in the backlight model storage unit 1014 and the brightness data of the N image zones determined by the zone calculation unit 1011 described above and then sends the grayscale-compensated current image frame to a timing control chip 201 in the liquid crystal display module 200.

Still as illustrated in FIG. 3, the MCU chip can be further integrated with a reception unit 1024, a power control unit 1025 and an adjustment unit 1026, wherein the reception unit 1024 is connected to the zone calculation unit 1011 of the FRC chip and receives the backlight values of the N backlight zones determined by the zone calculation unit 1011 by a Serial Peripheral Interface (SPI); and the power control unit 1025 is connected to the backlight value adjustment unit 1023, and when the average of the backlight values in any backlight area being above a preset threshold (the value of the preset threshold is typically approximately 70% of the highest brightness value 255) is detected, the power control unit 1025 searches a preset power adjustment curve for a power adjustment coefficient corresponding to the average of the backlight values in the backlight area and adjusts the brightness of the backlight area by the power adjustment coefficient, wherein the power adjustment curve can be pre-stored in the power control unit 1025. Particularly as illustrated in FIG. 4, there is a schematic diagram of a power adjustment curve according to the embodiment of the disclosure, where the abscissa represents a backlight value in the range of [0,255], and the ordinate represents an adjustment coefficient in the range of (0,1].

Since the backlight value adjustment unit 1023 further takes into account a power bearing capacity of a backlight module while improving the brightness of a backlight area, the power control unit 1025 constantly detects the average of the backlight values enhanced by a gain in a backlight area, and if the average being above the preset threshold is detected, then it indicates that the brightness in the backlight area has been saturated and will not be significantly improved even if the backlight values are improved by the current gain, but on the contrary, high power consumption will arise. Thus with the disclosure, the preset power adjustment curve is searched for a corresponding power adjustment coefficient (typically below 1) for the backlight area with the average of the backlight values being above the preset threshold, and then the backlight values of all the backlight zones in the backlight area are multiplied by the power adjustment coefficient. Although the resulting backlight values are lower, the brightness can be improved and also the power consumption of the display module can be lowered, wherein the power adjustment curve can be derived empirically and then pre-stored in the power control unit.

Since the backlight control apparatus 100, the liquid crystal module 200, etc., described above are typically integrated in a terminal device, e.g., a TV set device, a user can preset and store in a main control chip of the TV set device a global dimming signal under a dimming rule of a backlight module in the TV set device, wherein the global dimming signal can be a Pulse Width Modulation (PWM) signal; and the adjustment unit 1026 parses the global dimming signal and multiplies the backlight values received by the reception unit 1024 by a duty ratio of the parsed global dimming signal to derive the adjusted backlight values as a criterion for the backlight area division unit 1021 to determine the average of the backlight values of the backlight zones included in the backlight area, wherein the global dimming signal can be adjusted by the user using a remote controller or another device and pre-stored in the TV set device for the purpose of adjusting the brightness contrast of panel backlight as desired by the user while displaying the video data.

With the foregoing embodiment, the backlight control apparatus of the liquid crystal panel including the FRC chip, the MCU chip and the backlight drive chip calculates the brightness data of the N image zones of the adjusted current image frame, converts the brightness data of the N image zones into the backlight values of the N backlight zones and sends the backlight values to the Micro Controller Unit (MCU) chip; and the MCU chip divides the N backlight zones into the M backlight areas, searches the preset gain curve for the gain corresponding to each backlight area according to the average of the backlight values of the backlight zones included in the each backlight area, and adjusts the backlight values of the backlight zones by the M gains searched for, so that the different gains can be searched for in accordance with the different backlight areas to perform different dimming control on the different backlight areas and treat the different backlight areas differently so that the resulted backlight values of the respective backlight zones are different in accordance with the different backlight areas, and furthermore the brightness contrast of the video data being displayed and the layered perception of the display picture are improved; and also resolution adjustment and frame rate conversion can be performed on the current image frame in the received video data to thereby ensure the dynamic definition of the video data and the natural fluency of the picture, where the operation of resolution adjustment and frame rate conversion can be performed before the brightness data of the N image zones is determined or after the brightness data of the N image zones is determined, and the disclosure will not be limited to any order at which the operation is performed.

In summary, in the embodiment of the disclosure, the FRC chip and the MCU chip are connected by the Serial Peripheral Interface (SPI) to generate the backlight control apparatus of the liquid crystal panel capable of resolution and frame rate conversion function and of a zoning dimming function of backlight zones, in combination with control of the backlight drive chip, to thereby ensure the dynamic definition of the video data and the natural fluency of the picture and also improve the brightness contrast of the video data being displayed and the layered perception of the display picture.

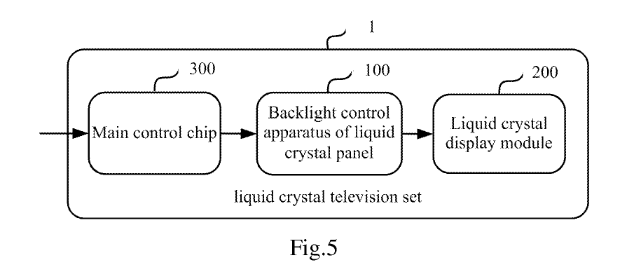

Based upon the same inventive idea as the backlight control apparatus of the liquid crystal panel described above, another embodiment of the disclosure provides a liquid crystal TV set, and as illustrated in FIG. 5, the liquid crystal TV set 1 includes the backlight control apparatus of the liquid crystal panel 100, the liquid crystal display module 200, the main control chip 300, etc. An external video data signal is input to the main control chip 300 and decoded and then transmitted to the backlight control apparatus of liquid crystal panel 100, and the backlight control apparatus of the liquid crystal panel sends the processed video data to the timing control chip 201 of the liquid crystal display module 200 to drive a liquid crystal panel for display. Also gain-adjusted backlight values of backlight zones are sent by the backlight drive chip 103 to a backlight module 202 of the liquid crystal display module 200 for backlight control.

Those skilled in the art shall appreciate that the embodiments of the disclosure can be embodied as a method, a system or a computer program product. Therefore the disclosure can be embodied in the form of an all-hardware embodiment, an all-software embodiment or an embodiment of software and hardware in combination. Furthermore the disclosure can be embodied in the form of a computer program product embodied in one or more computer useable storage mediums (including but not limited to a disk memory, a CD-ROM, an optical memory, etc.) in which computer useable program codes are contained.

The disclosure has been described in a flow chart and/or a block diagram of the method, the device (system) and the computer program product according to the embodiments of the disclosure. It shall be appreciated that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational steps are performed on the computer or the other programmable data processing device to create a computer implemented process so that the instructions executed on the computer or the other programmable device provide steps for performing the functions specified in the flow(s) of the flow chart and/or the block(s) of the block diagram.

Although the preferred embodiments of the disclosure have been described, those skilled in the art benefiting from the underlying inventive concept can make additional modifications and variations to these embodiments. Therefore the appended claims are intended to be construed as encompassing the preferred embodiments and all the modifications and variations coming into the scope of the disclosure.

Evidently those skilled in the art can make various modifications and variations to the disclosure without departing from the spirit and scope of the disclosure. Thus the disclosure is also intended to encompass these modifications and variations thereto so long as the modifications and variations come into the scope of the claims appended to the disclosure and their equivalents.

1. A backlight control apparatus of a liquid crystal panel, comprising:
a Frame Rate Conversion (FRC) chip configured to calculate brightness data of N image zones of a current image frame, to convert the brightness data of the N image zones into backlight values of N backlight zones and to send the backlight values to a Micro Controller Unit (MCU) chip;
the MCU chip configured to divide the N backlight zones into M backlight areas, to search a preset gain curve for a gain corresponding to each backlight area according to an average of the backlight values of the backlight zones comprised in the each backlight area, to adjust the backlight values of the N backlight zones by M gains searched for and to send the adjusted backlight values of the N backlight zones to a backlight drive chip, wherein both M and N are positive integers and M is no larger than N; and
the backlight drive chip configured to control Light Emitting Diode (LED) backlight sources of the N backlight zones by the received backlight values.

2. The apparatus according to claim 1, wherein the FRC chip comprises:
a zone calculation unit configured to divide the current image frame into the N image zones according to a size of a backlight model, to calculate the brightness data of each image zone respectively and to convert the brightness data into the backlight values of the N backlight zones; and
the FRC chip further comprises:
a resolution adjustment unit configured to adjust resolution of the current image frame in video data.

3. The apparatus according to claim 1, wherein the MCU chip particular comprises:
a reception unit configured to receive the backlight values of the N backlight zones;
a backlight area division unit configured to divide the N backlight zones corresponding to the N image zones into the M backlight areas, to determine the average of the backlight values in the each backlight area according to the backlight values of the backlight zones comprised in the backlight area;
a gain search unit configured to search the preset gain curve for the gain corresponding to the each backlight area according to the average of the backlight values in the each backlight area determined by the backlight area division unit; and
a backlight value adjustment unit configured to multiply the backlight values of the respective backlight zones in the corresponding backlight area by the M gains searched for by the gain search unit to derive the N backlight values enhanced by the gain.

4. The apparatus according to claim 3, wherein the MCU chip further comprises:
a power control unit configured, when the average of the backlight values in any backlight area adjusted by the backlight value adjustment unit being above a preset threshold is detected, to search a preset power adjustment curve for a power adjustment coefficient corresponding to the backlight area, and to multiply the backlight values of the backlight zones comprised in the backlight area respectively by the power adjustment coefficient to derive the adjusted backlight values of the respective backlight zones in the backlight area.

5. The apparatus according to claim 4, wherein the MCU chip further comprises:
a brightness data adjustment unit configured to parse a global dimming signal sent by a main control chip and to multiply the backlight values of the N backlight zones, received by the reception unit, by a duty ratio of the parsed global dimming signal to derive the adjusted backlight values of the N backlight zones.

6. The apparatus according to claim 4, wherein the MCU chip is connected with the FRC chip by a Serial Peripheral Interface (SPI).

7. A liquid crystal television set, comprising a backlight control apparatus of a liquid crystal panel, wherein the backlight control apparatus of the liquid crystal panel comprises:
a Frame Rate Conversion (FRC) chip configured to calculate brightness data of N image zones of a current image frame, to convert the brightness data of the N image zones into backlight values of N backlight zones and to send the backlight values to a Micro Controller Unit (MCU) chip;
the MCU chip configured to divide the N backlight zones into M backlight areas, to search a preset gain curve for a gain corresponding to each backlight area according to an average of the backlight values of the backlight zones comprised in the each backlight area, to adjust the backlight values of the N backlight zones by M gains searched for and to send the adjusted backlight values of the N backlight zones to a backlight drive chip, wherein both M and N are positive integers and M is no larger than N; and
the backlight drive chip configured to control Light Emitting Diode (LED) backlight sources of the N backlight zones by the received backlight values.

8. The television set according to claim 7, wherein the FRC chip comprises:
a zone calculation unit configured to divide the current image frame into the N image zones according to a size of a backlight model, to calculate the brightness data of each image zone respectively and to convert the brightness data into the backlight values of the N backlight zones; and
the FRC chip further comprises:
a resolution adjustment unit configured to adjust resolution of the current image frame in video data.

9. The television set according to claim 7, wherein the MCU chip particular comprises:
a reception unit configured to receive the backlight values of the N backlight zones;
a backlight area division unit configured to divide the N backlight zones corresponding to the N image zones into the M backlight areas, to determine the average of the backlight values in the each backlight area according to the backlight values of the backlight zones comprised in the backlight area;
a gain search unit configured to search the preset gain curve for the gain corresponding to the each backlight area according to the average of the backlight values in the each backlight area determined by the backlight area division unit; and
a backlight value adjustment unit configured to multiply the backlight values of the respective backlight zones in the corresponding backlight area by the M gains searched for by the gain search unit to derive the N backlight values enhanced by the gain.

10. The television set according to claim 9, wherein the MCU chip further comprises:
a power control unit configured, when the average of the backlight values in any backlight area adjusted by the backlight value adjustment unit being above a preset threshold is detected, to search a preset power adjustment curve for a power adjustment coefficient corresponding to the backlight area, and to multiply the backlight values of the backlight zones comprised in the backlight area respectively by the power adjustment coefficient to derive the adjusted backlight values of the respective backlight zones in the backlight area.

11. The apparatus according to claim 10, wherein the MCU chip further comprises:
a brightness data adjustment unit configured to parse a global dimming signal sent by a main control chip and to multiply the backlight values of the N backlight zones, received by the reception unit, by a duty ratio of the parsed global dimming signal to derive the adjusted backlight values of the N backlight zones.

12. A Micro Controller Unit (MCU) chip, comprising:
a reception unit configured to receive backlight values of N backlight zones;
a backlight area division unit configured to divide the N backlight zones into M backlight areas, to determine an average of the backlight values in each backlight area according to the backlight values of the backlight zones comprised in the backlight area;
a gain search unit configured to search a preset gain curve for a gain corresponding to the each backlight area according to the average of the backlight values in the each backlight area determined by the backlight area division unit; and
a backlight value adjustment unit configured to multiply the backlight values of the respective backlight zones in the corresponding backlight area by the M gains searched for by the gain search unit to derive the N backlight values enhanced by the gain.

13. The chip according to claim 12, further comprising:
a power control unit configured, when the average of the backlight values in any backlight area adjusted by the backlight value adjustment unit being above a preset threshold is detected, to search a preset power adjustment curve for a power adjustment coefficient corresponding to the backlight area according to the average of the backlight values, and to multiply the backlight values of the backlight zones comprised in the backlight area respectively by the power adjustment coefficient to derive the adjusted backlight values of the respective backlight zones in the backlight area.

14. The chip according to claim 13, further comprising:
a brightness data adjustment unit configured to parse a global dimming signal sent by a main control chip and to multiply the backlight values of the N backlight zones, received by the reception unit, by a duty ratio of the parsed global dimming signal to derive the adjusted backlight values of the N backlight zones.
